(19) United States
(12) Patent Application Publication
(10) Pub. No.: US 2024/0334412 A1
(43) Pub. Date: Oct. 3, 2024

(54) SUB-BAND DETERMINATION FOR WIRELESS COMMUNICATIONS

(71) Applicant: ZTE Corporation, Shenzhen (CN)

(72) Inventors: Jing SHI, Shenzhen (CN); Xianghui HAN, Shenzhen (CN); Shuaihua KOU, Shenzhen (CN); Xing LIU, Shenzhen (CN); Wei GOU, Shenzhen (CN)

(73) Assignee: ZTE Corporation, Shenzhen, GD (CN)

(21) Appl. No.: 18/680,447

(22) Filed: May 31, 2024

Related U.S. Application Data
(63) Continuation of application No. PCT/CN2022/110682, filed on Aug. 5, 2022.

(51) Int. Cl. H04W 72/0453; H04W 72/23

(52) U.S. Cl. CPC H04W 72/0453; H04W 72/23

(57) ABSTRACT

This document relates to wireless communication involving a network device determining, and a user device receiving, a first physical downlink control channel (PDCCH) configuration for a first downlink (DL) bandwidth part (BWP) and a second PDCCH configuration for a first sub-band within an uplink (UL) BWP or within the DL BWP. The network device transmits, and the user device receives, a PDCCH in the first sub-band according to the second PDCCH configuration, or the network device receives, and the user device transmits, an UL transmission in the UL BWP or in a second sub-band. Also, a network device configures a DL sub-band within an UL BWP and an UL sub-band within a DL BWP, the user device receives the DL sub-band and UL sub-band configurations, and the network device and user device perform a DL transmission in the DL sub-band or an UL transmission in the UL sub-band.

### CROSS-REFERENCE TO RELATED APPLICATION(S)

This application is a continuation of International Patent Application No. PCT/CN2022/110682, filed Aug. 5, 2022. The contents of International Patent Application No. PCT/CN2022/110682 are herein incorporated by reference in their entirety.

### TECHNICAL FIELD

This document is directed generally to sub-band determination in wireless communication.

### BACKGROUND

In wireless communication, time domain resources are split between downlink and uplink transmissions in time division duplex (TDD). Allocation of a limited time duration for uplink transmissions in TDD may result in reduced coverage, increased latency, and reduced capacity. Ways to enhance conventional TDD to improve these deficiencies may be desirable.

### SUMMARY

This document relates to methods, systems, apparatuses and devices for wireless communication. In some implementations, a method for wireless communication includes: receiving, by a user device, a first physical downlink control channel (PDCCH) configuration for a downlink (DL) bandwidth part (BWP) and a second PDCCH configuration for a first sub-band within an uplink (UL) BWP or within the DL BWP; and receiving, by the user device, a PDCCH in the first sub-band according to the second PDCCH configuration or transmitting, by the user device, an UL transmission in the UL BWP or in a second sub-band.

In some other implementations, a method for wireless communication includes: determining, by a network device, a first physical downlink control channel (PDCCH) configuration for a downlink (DL) bandwidth part (BWP) and a second PDCCH configuration for a first sub-band within an uplink (UL) BWP or within the DL BWP; and transmitting, by the network device, a PDCCH in the first sub-band according to the second configuration or receiving, by the network device, an UL transmission in the UL BWP or in a second sub-band.

In some other implementations, a method for wireless communication includes: receiving, by a user device, a configuration of a downlink (DL) sub-band within an uplink (UL) bandwidth part (BWP); receiving, by the user device, a configuration of an UL sub-band within a DL BWP; and performing, by the user device, a DL transmission in the DL sub-band or an UL transmission in the UL sub-band.

In some other implementations, a method for wireless communication includes: configuring, by a network device, a downlink (DL) sub-band within an uplink (UL) bandwidth part (BWP); configuring, by the network device, an UL sub-band within a DL BWP; and transmitting, by the network device, a DL transmission in the DL sub-band and/or receiving, by the network device, an UL transmission in the UL sub-band.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a flow chart of a method of wireless communication that involves sub-bands.

FIG. 3 shows a flow chart of another method of wireless communication that involves sub-bands.

FIG. 4 shows a time-frequency diagram of an example configuration of time-frequency resources including an uplink (UL) sub-band.

FIG. 5 shows a time-frequency diagram of another example configuration of time-frequency resources including an UL sub-band and a downlink (DL) sub-band.

FIG. 6 shows a time-frequency diagram of another example configuration of time-frequency resources including an UL sub-band and a downlink (DL) sub-band.

FIG. 7 shows a time-frequency diagram of another example configuration of time-frequency resources including an UL sub-band and a downlink (DL) sub-band.

FIG. 8 shows a time-frequency diagram of another example configuration of time-frequency resources including an UL sub-band and a downlink (DL) sub-band.

FIG. 9 shows a time-frequency diagram of another example configuration of time-frequency resources including an UL sub-band and a downlink (DL) sub-band.

FIG. 10 shows a time-frequency diagram of another example configuration of time-frequency resources including a first sub-band and a second sub-band.

FIG. 11 shows a time-frequency diagram of another example configuration of time-frequency resources including an UL sub-band.

FIG. 12 shows a flow chart of another method of wireless communication that involves sub-bands.

FIG. 13 shows a flow chart of another method of wireless communication that involves sub-bands.

FIG. 14 shows a time-frequency diagram of another example configuration of time-frequency resources includes an UL sub-band and DL sub-band, and further includes PDCCH resources within a DL BWP.

FIG. 15 shows a time-frequency diagram of another example configuration of time-frequency resources including an UL sub-band, a DL sub-band, and one or more monitoring occasions (MO).

FIG. 16 shows a time-frequency diagram of another example configuration of time-frequency resources including an UL sub-band, a DL sub-band, and MOs.

FIG. 17 shows a time-frequency diagram of another example configuration of time-frequency resources including a first sub-band and a second sub-band.

### DETAILED DESCRIPTION

The present description describes various embodiments of systems, apparatuses, devices, and methods for wireless communications involving sub-bands.

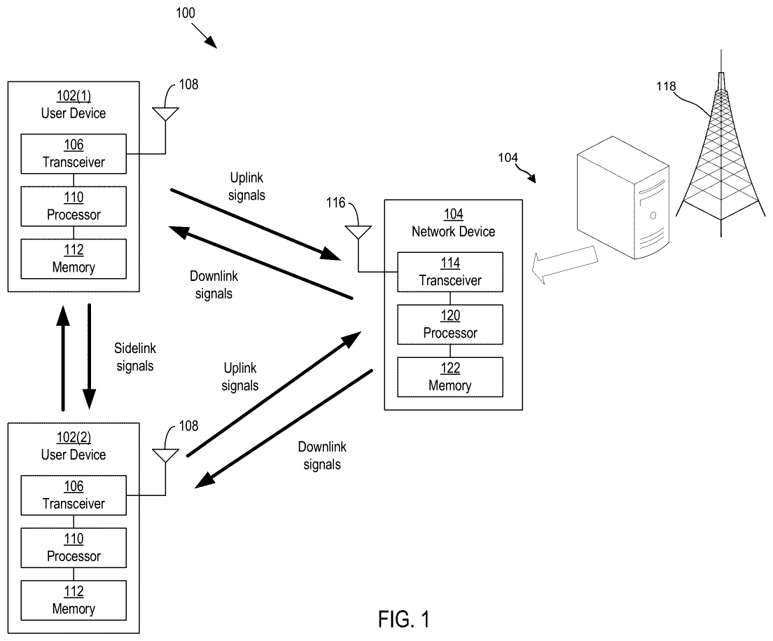

FIG. 1 shows a diagram of an example wireless communication system 100 including a plurality of communication nodes (or just nodes) that are configured to wirelessly communicate with each other. In general, the communication nodes include at least one user device 102 and at least one network device 104. The example wireless communication system 100 in FIG. 1 is shown as including two user devices 102, including a first user device 102(1) and a second user device 102(2), and one device 104. However, various other examples of the wireless communication system 100 that include any of various combinations of one or more user devices 102 and/or one or more network devices 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the network device 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a network device as described herein, such as the network device 104, may include a single electronic device or apparatus, or multiple (e.g., a network of) electronic devices or apparatuses, and may comprise one or more wireless access nodes, base stations, or other wireless network access points capable of communicating wirelessly over a network with one or more user devices and/or with one or more other network devices 104. For example, the network device 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A network device 104 may include transceiver circuitry 114 coupled to an antenna 116, which may include an antenna tower 118 in various approaches, to effect wireless communication with the user device 102 or another network device 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a network device 104, two user devices 102 without a network device 104, or two network devices 104 without a user device 102—may be configured to wirelessly communicate with each other in or over a mobile network and/or a wireless access in network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a network device 104. A downlink signal is a signal transmitted from a network device 104 to a user device 102. A sidelink signal is a signal transmitted from a one user device 102 to another user device 102, or a signal transmitted from one network device 104 to a another network device 104. Also, for sidelink transmissions, a first/source user device 102 directly transmits a sidelink signal to a second/destination user device 102 without any forwarding of the sidelink signal to a network device 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a network device 104 to a user device 102. In other embodiments, the control information includes uplink control information (UCI) that is transmitted in the uplink direction from a user device 102 to a network device 104, or sidelink control information (SCI) that is transmitted in the sidelink direction from one user device 102(1) to another user device 102(2).

In addition, one or more of the user devices 102 and/or the network device 104 may support sub-band non-overlapping full duplex (SBFD), at least at the network device 104 side, within a time-division duplex (TDD) band. Also, the SBFD may be supported on TDD carrier. In the embodiments described herein, SBFD may be employed with one or more uplink (UL) sub-bands, one or more downlink (DL) sub-bands, or a combination of one or more UL sub-bands and one or more DL sub-bands. Also, various ways to determine time and/or frequency resources for a UL or DL sub-band, or for a channel or signal within a UL or DL sub-band are described herein.

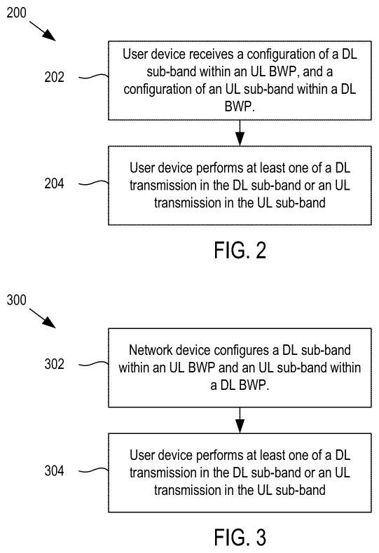

FIG. 2 shows a flow chart of an example method 200 of wireless communication that involves sub-bands. At block 202, a user device 102 may receive a configuration of a DL sub-band within an UL bandwidth part (BWP). Also, the user device 102 may receive a configuration of a UL sub-band within a DL BWP. At block 204, the user device 102 may perform at least one of a DL transmission in the DL sub-band or an UL transmission in the UL sub-band.

FIG. 3 shows a flow chart of another example method 300 of wireless communication that involves sub-bands. At block 302, a network device 104 may configure a DL sub-band within an UL BWP. Also, the network device 104 may configure an UL sub-band within a DL BWP. At block 304, the network device 104 may at least one of: transmit a DL transmission in the DL sub-band, or receive an UL transmission in the UL sub-band.

In addition, in some embodiments, a configuration of a given sub-band (such as a DL sub-band or an UL sub-band), may include, specify, and/or indicate time and/or frequency resources of the given sub-band, or a channel and/or signal configuration for the given sub-band, as non-limiting examples. Other information used by the network device 104 and/or the user device 102 to communicate on or in the given sub-band may be included in, or specified or indicated by the configuration of the given sub-band, in any of various embodiments.

In addition, in some embodiments of the method 200 and/or the method 300, the DL sub-band and the UL sub-band may have a same center frequency, a same frequency resource, and different time resources. In other embodiments, the DL sub-band and the UL sub-band may have a same center frequency, different frequency resources, and different time resources. In still other embodiments, the DL sub-band and the UL sub-band have a same frequency resource or different frequency resources, and a same time resource. In yet other embodiments, the time-frequency resources for the DL sub-band and the UL sub-band are independently determined by at least one of the network device 104 or the user device 102.

In addition or alternatively, at least one of the user device 102 or the network device 104 may apply collision resolution or a fallback mechanism in response to overlapped resources between the DL sub-band and the UL sub-band. In addition or alternatively, at least one of the user device 102 or the network device 104 may use a resource allocation method, e.g. a bitmap or a resource indication value (RIV), to derive frequency resources of at least one of a gap, the DL sub-band, or the UL sub-band.

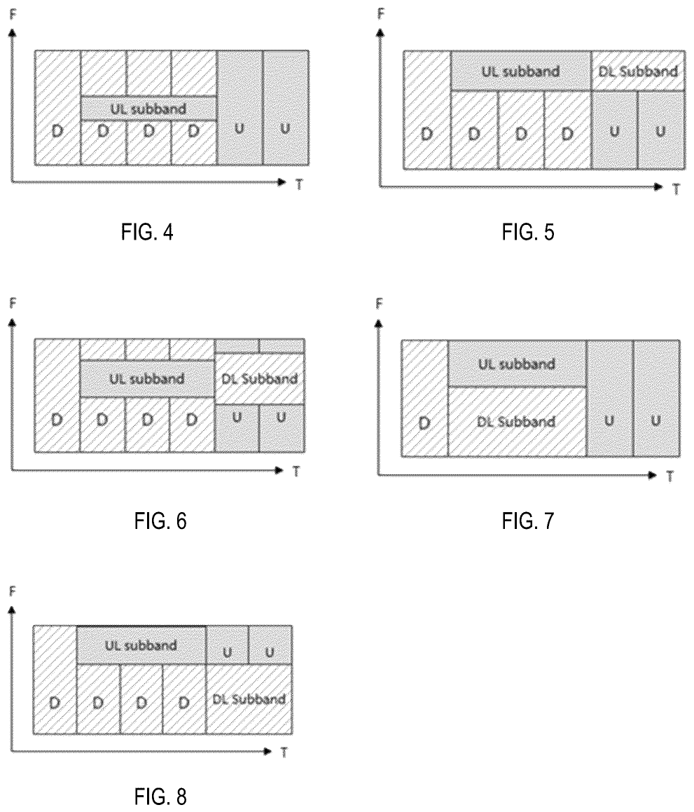

In further detail, in various embodiments, the user device 102 and/or the network device 104 may utilize a TDD carrier to support SBFD operation. Also, an UL sub-band may be configured on downlink or flexible (D or F) slots or symbols within consecutive resources. FIG. 4 shows a time-frequency diagram illustrating SBFD with only an UL sub-band. In FIG. 4, each “D” represents DL slots or symbols which can be represented as a set of time-frequency resources designated or configured for one or more DL transmissions, and each “U” represents UL slots or symbols which can be represented as a set of time-frequency resources designated or configured for one or more UL transmissions. FIG. 4 shows six time-frequency resource sets configured consecutively in time, including four DL time-frequency resource sets followed by two UL time-frequency resource sets. In various embodiments, the frequency resources for a given time-frequency resource set may extend over a carrier, band, bandwidth part (BWP) or other predetermined frequency range. Also, the time resources for a given time-frequency resource set may extend over a least one unit of time, such as at least one symbol or at least one slot, for example. The UL sub-band is shown in FIG. 4 as extending in time over the second, third, and fourth time-frequency resource sets. Also, the UL sub-band is shown in FIG. 4 has having consecutive frequency resources extending over a frequency range that is smaller than the total frequency range (e.g., carrier, band, or BWP) of the time-frequency resource sets.

Other embodiments may include only a DL sub-band, or both one more UL sub-bands and one or more DL sub-bands. A DL sub-band may extend in an UL time-frequency resource set, and a UL sub-band may extend in a DL time-frequency resource set. The DL sub-band may extend in time and/or be configured within U or F slots or symbols, and/or extend in frequency within a certain UL frequency range, such within an UL BWP. Additionally, the UL sub-band may extend in time and/or be configured within D or F slots or symbols, and/or extend in frequency within a certain DL frequency range, such as within a DL BWP.

In some embodiments including an UL sub-band and a DL sub-band, such as shown in FIG. 5, a UL sub-band and a DL sub-band may have the same frequency resources, the same center frequency, and different time resources. FIG. 5 shows a time-frequency diagram illustrating SBFD with a UL sub-band and a DL-sub-band. In particular, FIG. 5 shows the UL sub-band extending over three DL time-frequency resource sets. For example, the UL sub-band may extend in time over three DL slots or symbols, and may extend in frequency within a DL BWP. In addition, FIG. 5 shows the DL sub-band extending over two UL time-frequency resource sets. For example, the DL sub-band may extend in time over two DL slots or symbols, and extend in frequency within an UL BWP. Also, the UL sub-band and the DL sub-band have the same frequency resources and the same center frequency, and have different, non-overlapping time resources.

In other embodiments including an UL sub-band and a DL sub-band, such as shown in FIG. 6, a UL sub-band and a DL sub-band may have the same center frequency, different (or non-identical) frequency resources, and different, non-overlapping time resources. For example, the UL sub-band may be extend in time over, or be configured within, D and/or F slots and/or symbols, and/or extend in frequency within a DL BWP. Also, the DL sub-band may extend in time over, or be configured within, U and/or F slots and/or symbols, and/or extend in frequency within a UL BWP. Also, the center frequency of the UL sub-band and the DL sub-band are same, frequency domain resources of the UL sub-band and DL sub-band are different (e.g., the DL sub-band extends over a larger frequency range than the UL sub-band), and there are no overlapped resources in time domain between the UL sub-band and the DL sub-band.

In still other embodiments including an UL sub-band and a DL sub-band, such as shown in FIG. 7, an UL sub-band and a DL sub-band may have different center frequencies, different frequency resources, and the same or overlapping time resources. For example, such as shown in FIG. 7, both the UL sub-band and the DL sub-band may extend in the same time-frequency resource set. In FIG. 7, the UL sub-band and the DL sub-band both extend in the same DL time-frequency resources sets. Correspondingly, the UL sub-band and the DL sub-band both extend in time, or are configured to be within, D and/or F slots or symbols, and both extend in frequency within the same DL BWP. Other embodiments may configure the UL and DL sub-bands to extend or be configured within the same UL time-frequency resource sets. For such configurations, one sub-band may be considered to be on one side of the other sub-band in the frequency domain. Also, for at least some of these embodiments, the UL sub-band and the DL sub-band may be frequency division multiplexed (FDMed), while the UL and DL sub-bands have overlapped resources in the time domain.

In still other embodiments including an UL sub-band and a DL sub-band, such as shown in FIG. 8, the UL sub-band and the DL sub-band may have different frequency resources and different time resources. For example, as shown in FIG. 8, the UL sub-band extends in time over, or is configured within, D and/or F slots or symbols and extends in frequency within a DL BWP. Also, the DL sub-band extends in time over, or is configured within, U and/or F slots or symbols and extends in frequency within a UL BWP. Also, in the example in FIG. 8, the UL and DL sub-bands may have different center frequencies, and their respective resources in the time domain do not overlap.

Also, although not shown in FIGS. 4-8, in any of various embodiments, there may be one or more gaps inside and/or outside one or more of the UL sub-band or the DL sub-band. Also, in various embodiments, the SBFD examples shown in FIGS. 5, 6, and 8 may be considered to include time division multiplexed (TDMed) sub-bands, and the SBFD example in FIG. 7 may be considered to include FDMed sub-bands.

Accordingly, the various embodiments of sub-band non-overlapped full duplex (SBFD) operation utilizing a UL sub-band and/or a DL sub-band described, such as those described above with reference to FIGS. 4-8, may achieve better performance with respect to latency reduction and capacity improvement. Also, of in various embodiments, a same narrowband filtering may be used for embodiments where the UL sub-band and the DL sub-band have the same center frequency and same frequency resources. More flexible or a trade-off capacity could be achieved in case different frequency resources are used for the UL sub-band and the DL sub-band.

In addition or alternatively, in some situations employing SBFD operation, an UL sub-band and a DL sub-band may have overlapping resources in the time domain and/or the frequency domain. For such situations, the user device 102 and/or the network device 104 may employ collision resolution and/or a fallback mechanism.

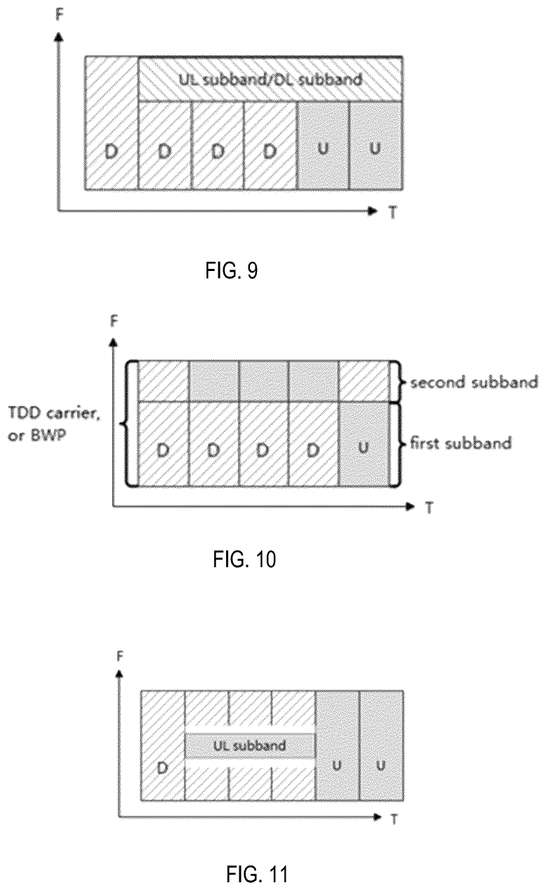

FIG. 9 shows a time-frequency diagram for SBFD operation where an UL sub-band and a DL sub-band have overlapping resources in the time domain. Also, in some situations of overlapping resources, such as shown in FIG. 9, the UL sub-band and the DL sub-band may have the same center frequency and/or the same frequency resources. In response to determining overlapping resources, such as in the example in FIG. 9, the user device 102 and/or the network device 104 may employ or apply collision resolution and/or a fallback mechanism.

In some embodiments where the user device 102 and/or the network device 104 employ collision resolution, the user device 102 and/or the network device 104 may determine to give a UL transmission in the UL sub-band higher priority than a DL transmission in the DL sub-band. In other embodiments, the user device 102 and/or the network device 104 may give a DL transmission in the DL sub-band higher priority than an UL transmission in the UL sub-band. In still other embodiments, the user device 102 and/or the network device 104 may give a dynamic scheduling transmission a higher priority than a semi-static transmission.

Also, in some embodiments where the user device 102 and/or the network device 104 employ a fallback mechanism, the user device 102 and/or the network device 104 may “fall back” or utilize the UL sub-band and/or the DL sub-band as a flexible sub-band in which a UL transmission and/or a DL transmission may be performed. Also, as used herein, the term “flexible” as used for time and/or frequency resources, such as sub-bands, slots, symbols, etc., refers to that the user device 102 may not make any assumptions as to the uplink or downlink transmission direction for that time or frequency resource, or a frame structure is configured/determined for the flexible sub-band. The user device 102 may transmit in the UL direction or receive in the DL direction on or in a given flexible time or frequency resource, depending on any scheduling or other configuration, such as determined by the network device 104.

For at least some of these embodiments, and/or in view of the SBFD example in FIG. 7, the network device 104 and/or the user device 102 may configure one or both of the UL and DL sub-bands such that time resources corresponding to the UL sub-band and/or the DL sub-band may have any of various combinations of D, F, and/or U slots or symbols, and/or frequency resources corresponding to the UL sub-band and/or the DL sub-band may extend within a DL BWP and/or an UL BWP. In addition or alternatively, one sub-band may implicitly or be derived to be located on one side of the other sub-band or on each side of the other sub-band.

FIG. 10 shows another time-frequency diagram that includes generally a first sub-band and a second sub-band. The user device 102 and/or the network device 104 may consider the first sub-band to be a DL BWP and the second sub-band to be an extended supplementary uplink (SUL) carrier with D slots/symbols. Such a first sub-band and a second sub-band may be configured within a single BWP, such as shown in FIG. 10. Also, in the example in FIG. 10, the center frequencies of the first and second sub-bands may be different, have different frequency domain resources and may be FDMed, while there are overlapped resources in time domain between the first and second sub-bands.

In addition, similar to the SBFD examples in FIGS. 4-8, in any of various embodiments in the examples in FIGS. 9 and 10, although not shown, there may be one or more gaps, inside or outside, of one or more sub-bands.

Accordingly, SBFD operation may be achieved by introducing a UL sub-band and/or a DL sub-band, which in turn may achieve better performance with respect to latency reduction and/or capacity improvement. Also, for at least some embodiments, latency reduction and capacity improvement may be further enhanced by configuring both DL resources and UL resources within a single flexible sub-band.

In addition or alternatively, for embodiments where a UL sub-band is configured on D/F slots/symbols and with consecutive frequency resources, an example frequency resource allocation of the UL sub-band may be determined or listed according to the following.

The network device 104 and/or the user device 102 may use a bitmap, with each bit corresponding to a respective one of X resource blocks (RBs) (e.g. X=6), to derive a frequency resource of gap and/or a sub-band. In addition or alternatively, the network device 104 and/or the user device 102 may explicitly use a RB-Offset indication to derive a gap on one inside of SBFD or both insides of SBFD.

A gap on one inside of SBFD may include that one gap occupies one or more RBs of a total number of RBs that are allocated to a given sub-band. For example, where a contiguous set of RBs are allocated to a given sub-band, one or more RBs constituting an upper bound or a lower bound of the set may be allocated to the gap, and the remaining RBs may actually allocated to or used for the given sub-band. For example, suppose a BWP is allocated 100 RBs, a given sub-band is allocated 40 RBs, and a gap is allocated 6 RBs. The phrase “gap on one inside of SBFD” may mean, e.g. that 0-39 RBs are allocated for the sub-band, 34-39 RBs are used for the gap, and in turn, the actual RBs used for the sub-band is 0-33 RBs. This case corresponds the sub-band is located in one side of the BWP.

Additionally, a gap on both insides of the SBFD may include that two gaps occupy two or more RBs of a total number of RBs that are allocated to a given sub-band. For example, where a contiguous set of RBs are allocated to a given sub-band, one or more RBs constituting an upper bound of the set may be allocated to a first gap, one or more RBs constituting a lower bound of the set may be allocated to a second gap, and a remaining number of RBs from the set may be actually allocated to the given sub-band. For example, suppose a BWP is allocated 100 RBs, a given subband is allocated 40 RBs, and a gap is allocated 6RB. The phrase “gap on both insides of SBFD” may mean, e.g. that 10-49 RBs are allocated for the sub-band, 10-12 RBs and 47-49 RBs are used for the gap (e.g., 10-12 RBs are used for a first gap and 47-49 RBs are used for a second gap), and in turn, the actual RBs used for the subband are 13-46 RBs. This case corresponds to the sub-band being located in the middle of the BWP.

In some embodiments, a frequency domain resource of a BWP is determined by a starting physical resource block (PRB) and the length of a plurality of PRBs. Suppose that the starting PRB is referenced to a Point A, i.e., the starting PRB is a PRB determined by subcarrierSpacing of the associated BWP and offsetToCarrier corresponding to this subcarrier spacing, combined with the number of RBs indicated by the parameter of locationAndBandwidth of a BWP using a resource indication value (RIV) with the consecutive resource allocation. The current frequency domain resource of a CORESET is determined by a bitmap in a DL BWP with each bit corresponding to respective RB a group of 6 RBs.

In further detail, in some embodiments, a value of NG (the number of RBs of a gap) is 6 or 3 RBs. Also, in some embodiments, a value of Nu (the number of RBs of a given UL sub-band) is about 50 to 70 RBs, which may equate to about 20% of the channel bandwidth. In case a UL sub-band is configured within a DL BWP, in order to avoid a resource collision between a control resource set (CORESET) and the UL sub-band, the frequency resource allocation used to determine a CORESET is also used to determine or derive a frequency resource of a gap and/or one or more sub-bands used for SBFD. The benefit is to match the resource grid of PDCCH. FIG. 11 shows a time-frequency diagram that includes a UL-sub-band and a gap on each side of the UL-sub-band. As shown in FIG. 11, the UL sub-band and the gaps on each side are configured. Correspondingly, the user device 102 and/or the network device 104 may employ a method of resource allocation, such as a bitmap, with each bit corresponding to a respective one of X RBs (e.g. X=6), or RIV to derive a frequency resource of the UL sub-band. However, regardless of whether a RIV or a bitmap is used to determine the UL sub-band, in some embodiments, the network device 104 and/or the user device 102 may use a RB-Offset indication to derive a gap on one inside of SBFD or both insides of SBFD. For example, RB_offset=3RB may be used to locate each inside of SBFD. As another example, RB_offset=6RB may be used to locate one inside of SBFD.

Accordingly, as mentioned, SBFD operation may using an UL sub-band and/or a DL sub-band may achieve better performance with respect to latency reduction and/or capacity improvement. Moreover, use of the same frequency domain resource allocation for a CORESET and the UL sub-band may avoid, or facilitate avoiding, resource collision between the UL sub-band and the CORESET by aligning the resource grid of the DL control channel.

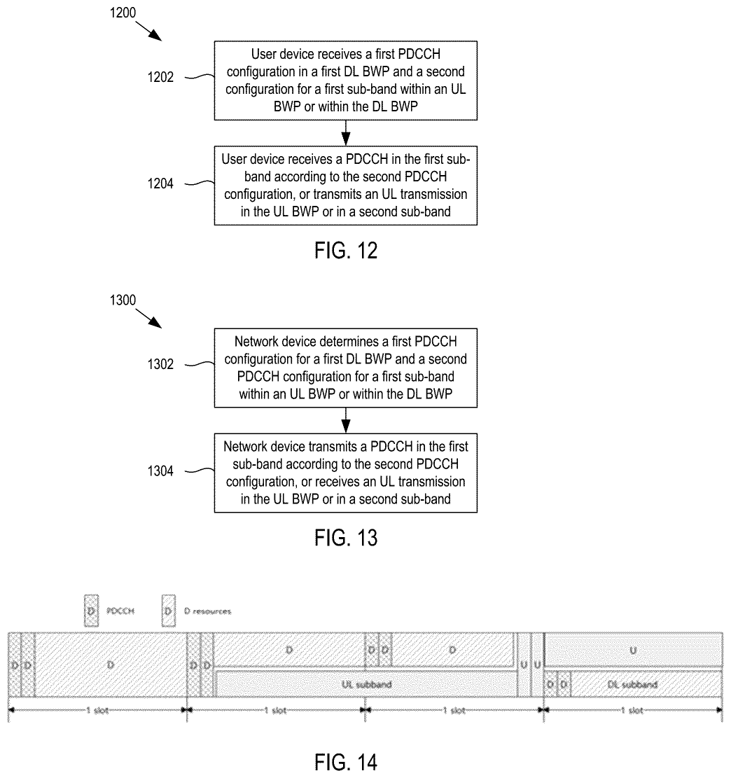

FIG. 12 shows a flow chart of a method 1200 for wireless communication that involves sub-bands. At block 1202, a user device 1202 may receive a first PDCCH configuration in a first DL BWP and a second configuration for a first sub-band within an UL BWP or within the DL BWP. At block 1204, the user device 102 may at least one of receive a PDCCH in the first sub-band according to the second PDCCH configuration, or may transmit, an UL transmission in the UL BWP or in a second sub-band.

FIG. 13 shows a flow chart of a method 1300 for wireless communication that involves sub-bands. At block 1302, a network device 104 may determine a first PDCCH configuration for a first DL BWP and a second PDCCH configuration for a first sub-band within an UL BWP or within the DL BWP. At block 1304, the network device 1304 may at least one of transmit a PDCCH in the first sub-band according to the second PDCCH configuration, or receive an UL transmission in the UL BWP or in a second sub-band.

For at least some embodiments of the method 1200 and/or the method 1300, the first sub-band includes a DL sub-band or a flexible sub-band, and the second sub-band includes an UL sub-band or a flexible sub-band.

Additionally, in some embodiments, the first PDCCH configuration and the second PDCCH configuration may be the same PDCCH configuration. For at least some of these embodiments, the same PDCCH configuration may indicate at least one of: independent control resource sets (CORESETSs) or independent search spaces for the first sub-band and the DL BWP. In particular of these embodiments, a CORESET used for the PDCCH in the DL sub-band is configured within the DL BWP, the UL BWP, or the first sub-band. For some other of these embodiments, the same PDCCH configuration may indicate at least one of: a same CORESET or a same search space for the DL BWP and the first sub-band. In particular of these embodiments, the a collision between a monitoring occasion (MO) and UL resources of the UL BWP may cause the user device 102 to override one of the MO and the UL resources in favor of the other of the MO and the UL resources. The MO is used for PDCCH monitoring.

In further detail, in some embodiments where a DL sub-band or an extended SUL carrier with DL slots/symbols (also referred to as a second sub-band) is used, a same or shared PDCCH configuration (PDCCH-config) that is used for both a DL BWP and the DL sub-band or the extended SUL carrier. In other embodiments, a second or different PDCCH configuration (PDCCH-config) may be used for the DL sub-band or extended SUL carrier. FIG. 14 shows a time-frequency diagram that shows PDCCH resources within a DL BWP and a DL sub-band configured by a shared PDDCH config.

In some embodiments, frequency domain resources and time domain resources of a PDCCH are determined by a CORESET and search space configuration. The network device 104 and/or the user device 102 may determine a PDCCH transmitted in a DL sub-band in one of several ways.

In a first way, there is no PDCCH in the DL sub-band. For at least some of these embodiments, the DL sub-band is used only for DL traffic transmissions. In this context, the DL sub-band may be regarded as a flexible DL sub-band (or just flexible sub-band). That is, how the DL sub-band is used may depend on gNB scheduling whether certain resources are used for a DL sub-band or as U slots/symbols. In this way, the network device 104 does not permit a PDCCH to be transmitted in a DL sub-band. This, in turn, may provide additional opportunities for a DL transmission in U slots/symbols, and the same opportunities for PDCCH transmissions are present as if no DL sub-band existed.

In a second way, the user device 102 and/or the network device 104 and/or the user device 102 may determine independent CORESETs and/or independent search spaces for the DL BWP and the DL sub-band. For at least some of these embodiments, the CORESET used for the PDCCH in the DL sub-band is configured within the DL BWP, the UL BWP, or DL sub-band. That is, the frequency range for the resource allocation of the CORESET is within the DL BWP, the UL BWP, or the DL sub-band. In addition or alternatively, a PDCCH demodulation reference signal (DMRS) reference k0 may be a subcarrier 0 in a common resource block 0 or RB 0 of the DL sub-band. In addition or alternatively, before the network device 104 and/or the user device 102 configures the DL sub-band, a UE-specific search space (USS) that is configured, or that occurs, in U slots/symbols may be used for the DL sub-band. That is, the CORESET and/or search space may be independently configured for a radio resource control (RRC) connected mode of the user device 102. For example, for an Idle/inactive mode of the user device 102, the DL sub-band is not available. However, after the user device 102 enters into the RRC connected mode, the user device 102 and/or the network device 104 may configure an additional search space and/or CORESET in the resource of the DL sub-band. These embodiments of the second way may provide for a more flexible configuration. Also, in some embodiments, the CORESET is configured based on the DL BWP. That is, the first (left-most/most significant) bit corresponds to the first RB group in the BWP, and so on. A bit that is set to 1 indicates that this RB group belongs to the frequency domain resource of this CORESET. Bits corresponding to a group of RBs not fully contained in the bandwidth part within which the CORESET is configured are set to zero. The CORESET used in DL sub-band can be configured based on the DL BWP, the UL BWP, or the DL sub-band to determine the region of frequency domain for the allocation. Additionally, in some embodiments, the current PDCCH DMRS reference k0 is determined by subcarrier 0 of the lowest-numbered resource block in the CORESET #0 or subcarrier 0 in the common resource block 0. For the CORESET used in the DL sub-band, the PDCCH DMRS reference k0 is determined by subcarrier 0 in common resource block 0 or subcarrier 0 of the lowest-numbered resource block in the DL sub-band. In case the DL sub-band is not, or has not been, configured, the network device 104 and/or the user device 102 may determine which USS to use for the DL sub-band. For example, the network device 104 and/or the user device 102 may determine a monitoring occasion (MO) or a USS that occurs in the U slots/symbols as the USS used in DL sub-band. Furthermore, in case the MO configured for the DL BWP (or the DL sub-band) occurs in the DL sub-band (or the DL BWP), then if the MO is valid, then a monitored PDCCH may also be valid, or if the MO is invalid, then the PDCCH can be dropped, omitted, overridden.

Also, in some situations, the second way may provide one or more restrictions. In a first restriction, only partial symbols can be used for a PDCCH, e.g. first one or two symbols in a slot within the DL sub-band may be used for the PDCCH. In a second restriction, only a USS can be configured in the DL sub-band. That is, the DL sub-band is not used for initial access. In a third restriction, an UL transmission may be transmitted on the DL sub-band in event there is no DL traffic. That is, the DL sub-band is not only used for DL transmissions, which may improve capacity. In a fourth restriction, in event that a collision occurs between different signals/channels, the collision may be resolved by collision resolution, e.g. a DL transmission may override an UL transmission, or an UL transmission may override a DL transmission. In addition or alternatively, a PDCCH may not be transmitted on the DL sub-band.

In a third way, the network device 104 and/or the user device 102 may apply a current CORESET and/or search space configuration to original D/F slots/symbols and the DL sub-band. That is, the same CORESET and/or search space is used for the DL BWP and DL the sub-band. In at least some embodiments of the third way, the same CORESET and/or the same search space configuration for the DL BWP and the DL sub-band may include at least one of the following. First, all D/F/U slots/symbols may be used for a search space. Second, the network device 104 and/or the user device 102 may override a monitoring occasion (MO) in favor of UL resources, or may override the UL resources in favor of the MO. Third, one search space with dual search space duration/period may be used for the DL BWP and the DL sub-band, respectively. Also, in some of these embodiments, all D/F/U slots/symbols may be used for a search space due to the configured period/offset of the search space. For example, in case a UE capability of the DL sub-band supported is reported, the configuration for a USS may be applied for all D/F/U slots/symbols.

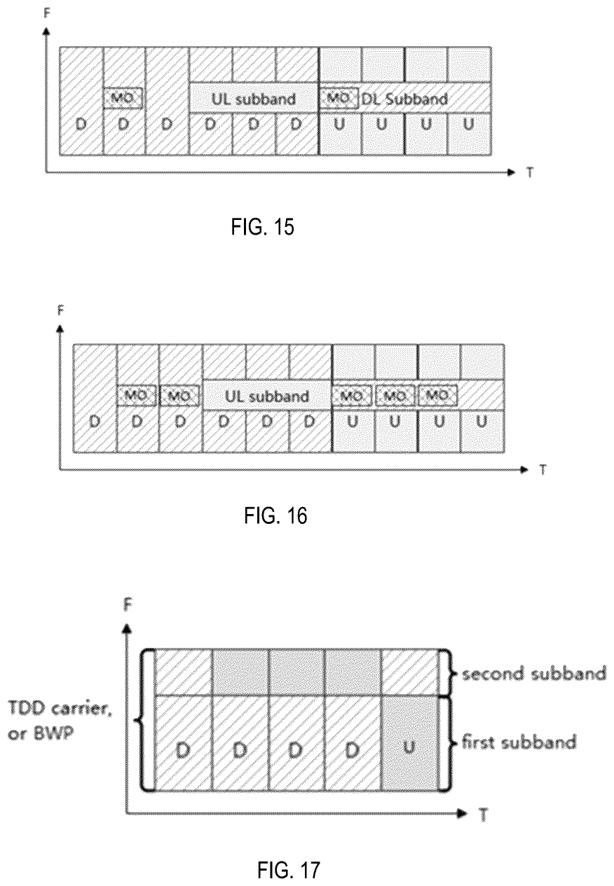

To illustrate, in the example time-frequency diagram in FIG. 15, a search space period=5 slots, and an offset=1 slot may be used for the TDD carrier with DL sub-band supported if the associated CORESET can be included in the DL sub-band. In event that the configuration of a MO collides with an UL sub-band or U slots/symbols, the following may be used or employed. First, in event that the collision between the MO and the UL sub-band or U slots/symbols is not expected, the user device 102 and/or the network device 104 may use more independent search space and/or CORESETs. In addition or alternatively, if the UL sub-band or U slots/symbols override the MO, then the MO is invalid in the collided resources. On the other hand, if the MO overrides the UL sub-band or U slots/symbols, then the MO is valid in the collided resources. In addition or alternatively, one search space with dual search space duration/period may be used for the DL BWP and the DL sub-band, respectively. As shown in FIG. 16, besides search space period=5 slots and offset=1 slot, a first search space duration (e.g., search space duration1)=2 slots, and a second search space duration (e.g., a search space duration2)=3 slots may be used for two contiguous periods, respectively. Other similar mechanisms, such as dual periods with each independent offset/search space duration configuration, may be used.

Accordingly, as mentioned, SBFD operation using one or more UL sub-bands and/or one or more DL sub-bands may achieve better performance with respect to latency reduction and capacity improvement. Also, in some embodiments, using the same or independent CORESETs and/or search spaces for the DL BWP and the DL sub-band based on shared PDCCH configurations may avoid introducing an additional PDCCH configuration for the DL sub-band. Moreover, a DL BWP configuration may be reused for the DL sub-band with minimum on implementation complexity.

In addition or alternatively, in event that a current PDCCH configuration is also used for the DL sub-band, a size of a DCI format in D slots/symbols and a size of the same DCI format in the DL sub-band may be aligned. Fields being determined by the same RRC configuration, e.g. shared PDCCH-config (and shared PDSCH-config) may facilitate such size alignment.

Also, for at least some embodiments where a same DCI format is used for the DL BWP and the DL sub-band, a bandwidth part indicator used in scheduling the DL sub-band may indicate whether or not to switch the DL BWP or the UL BWP, or may indicate that the field is reserved or is to be discarded for sub-band scheduling. In addition or alternatively, a rate matching indicator used in scheduling the DL sub-band can be reserved or used within the DL sub-band in the UL BWP.

Also, for some embodiments, a frequency domain resource allocation (FDRA) field, especially for the size of DL BWP and UL BWP, are not same. The frequency region of the allocation in the frequency domain in the DL sub-band may be based on the DL BWP, the UL BWP, or the DL sub-band. Similarly, the frequency region of the allocation in the frequency domain in the UL sub-band may be based on the DL BWP, UL BWP, or the UL sub-band.

In addition or alternatively, for some embodiments, the bandwidth part indicator may be implemented in DCI format 1_x or 0_x for DL sub-band and/or UL sub-band scheduling in any of the following ways. In a first way, the bandwidth part indicator may indicate whether to change a BWP having the same DL or UL direction as the DL or UL direction of the sub-band for which a DCI format including the bandwidth part indicator is included. For example, a bandwidth part indicator in DCI format 1_1 used for the DL sub-band may indicate whether to change the DL BWP. In a second way, the bandwidth part indicator may indicate whether to change a BWP having the opposite DL or UL direction as the DL or UL direction of the sub-band for which a DCI format including the bandwidth part indicator is included. For example, a bandwidth part indicator in a DCI format 1_1 used for the DL sub-band may indicate whether to change the UL BWP. In a third way, the bandwidth part indicator may be reserved for sub-band scheduling. For example, a bandwidth part indicator in a DCI format 1_1 used for the DL sub-band that indicates to change to another BWP may, in turn, indicate that field is reserved or is to be discarded by the user device 102.

In addition or alternatively, a rate matching indicator may be used in a DCI format 1_x for DL sub-band scheduling in any of various ways as follows. In one way, the rate matching (RM) indicator field may be the same size as used in the DL BWP and reserved. This may be the case because there is no rate matching pattern in U slots/symbols. In addition or alternatively, using the RM indication and a corresponding RM pattern may be extended to U slots/symbols or to the DL sub-band. In some embodiments, the same RM configured in the DL BWP, or an independent RM configured for the DL sub-band within DL sub-band or the UL BWP can be used. In case the same RM pattern is used, a wider RM pattern may be configured, in which case the network device 104 may only send signals (e.g. CSI-RS) within the DL sub-band, so as not to impact other resources in the UL BWP.

Accordingly, as mentioned, SBFD operation using one or more UL sub-bands and/or one or more DL sub-bands may achieve better performance with respect to latency reduction and capacity improvement. Also, using a shared PDCCH-config may avoid introducing an additional PDCCH-config for the DL sub-band, and the same DCI format can be used for both the DL BWP and the DL sub-band. Moreover, configurations for the DL BWP may be reused for the DL sub-band with minimum impact to implementation complexity.

Additionally, for some of embodiments of the method 1200 and/or the method 1300, the first PDCCH configuration and the second PDCCH configuration are different configurations. Also, for some of these embodiments where the PDCCH configurations are different, the second PDCCH configuration may determine one or more fields in a downlink control information (DCI) format used for scheduling a DL transmission in the first sub-band. In some examples, the DCI format includes an indication that indicates whether the DCI format is for the first sub-band or the DL BWP. In addition or alternatively, a total number of different DCI sizes with a cell radio network temporary identifier (C-RNTI) that the user device monitors is up to four.

Also, in some embodiments where the PDCCH configurations are different, at least one of: a search space budget for the user device comprises at least one of: more than 10 search spaces per BWP or more than 40 search spaces per cell; a CORESET budget for the user device comprises at least one of: more than 5 CORESETs per BWP or more than 16 CORESETs per cell; a search space budget comprises a first part for the DL BWP and a second part for the DL sub-band; or a CORESET budget comprises a first part for the DL BWP and a second part for the DL sub-band. In addition or alternatively, a blind decode budget or a control channel element (CCE) budget are the same for the DL BWP and the DL sub-band when the DL BWP and the DL sub-band are time-division multiplexed. In particular of these embodiments, the DL BWP and the DL sub-band may be counted as only one cell for carrier aggregation scaling. In addition or alternatively, in some embodiments where the PDCCH configurations are different, a blind decode budget or a control channel element (CCE) budget comprises a first part for the DL BWP and a second part for the DL sub-band. In particular of these embodiments, the DL sub-band is counted as one or more cells for carrier aggregation scaling. In addition or alternatively, in some embodiments where the PDCCH configurations are different, the user device 102 may perform dropping per slot for the DL BWP and the DL sub-band, such that the dropping per slot comprises one of: dropping per slot in a unified manner when a subcarrier spacing (SCS) and a user equipment-specific search space (USS) is shared between the DL BWP and the DL sub-band; dropping per slot for the DL BWP and the DL sub-band independent of each other; dropping per slot for the DL BWP and not for the DL sub-band; or dropping per slot for the DL BWP and the DL sub-band in a unified manner and according to a predetermined order when the DL BWP and the DL sub-band have independent user equipment (UE)-specific search spaces (USS).

In further detail, in some embodiments, the network device 104 and/or the user device 102 may use independent or different PDCCH configurations, for example, such that there is an independent or second PDCCH configuration configured for the DL subband or extended SUL with D slots/symbols (which may also be called a second sub-band). For at least some of these embodiments, one or more fields in the DCI format used for scheduling the DL sub-band may be determined by the independent or second PDCCH configuration. In addition or alternatively, one or more fields in the DCI format may be determined by a PDSCH configuration. FIG. 17 shows an example SBFD example, where an independent or second PDCCH configuration may be used for the DL sub-band, in that PDCCH resources within the DL sub-band are configured by the independent or second PDCCH configuration.

Also, for implementation of SBFD, DCI size budgets may be determined or used in any of various ways. In some embodiments, a DCI size budget may be the same for SBFD as it is for other wireless communications that do not use SBFD. In addition or alternatively, a same DCI format is used for both the DL BWP and the DL sub-band and/or the DCI format sizes for the DL BWP and the DL sub-band are aligned. In addition or alternatively, the same DCI format may have an indication for the DL sub-band and/or an indication for the DL BWP. In other embodiments, a different DCI format may be used for the DL BWP and the DL sub-band. In addition or alternatively, a DCI format for the DL sub-band may have the same size as a DCI format used for cells not configured with SBFD, but may include a different, second C-RNTI, or the size of the DCI format for the DL sub-band may be counted in another cell that does not have SBFD and/or sub-bands configured. In addition or alternatively, the user device 102 may utilize a DCI size budget (i.e., the total number of different DCI sizes that the user device 102 is configured to monitor for a cell) that is greater than ‘3+1’, and/or up to ‘4’ for DCI sizes using cyclic redundancy check (CRC) scrambling with a cell network temporary identifier (C-RNTI) configured.

In further detail, in some embodiments, a DCI size budget is ‘3+1’ per cell for the user device 102—that is, the total number of different DCI sizes the user device 102 is configured to monitor for a cell is no more than 4 for the cell, and the total number of different DCI sizes with C-RNTI that the user device 102 is configured to monitor is no more than 3 for the cell. In case a cell is configured with a DL sub-band or an extended SUL carrier with D slots/symbols (which can be also regarded as the second sub-band), and/or in case the independent or the second PDCCH configuration is configured for the DL sub-band or extended SUL carrier with D slots/symbols, a DCI size budget for the user device may be determined according to one of the following.

In a first option, a per cell DCI size budget is the same between cells where sub-bands are and are not configured. For some examples, for a DCI format (e.g. DCI format 1_x) used for D slots/symbols (or D resources on a virtual TDD carrier) and also used for the DL sub band (or D resources on a virtual SUL carrier), size may be aligned by padding in the end or for each field. Also, an indication for the DL sub-band may be used explicitly or implicitly. In other examples, a DCI format for scheduling in the DL sub-band (or in D resources on a virtual SUL carrier) may have a same size as a DCI format used for cells without sub-bands configured, but have a different radio network temporary identifier (RNTI) (e.g. a second C-RNTI), or may be counted in another cell, one that is not configured with SBFD and for which the DCI size budget is less than ‘3+1’.

In a second option, a per cell DCI size budget may be higher than a DCI budget for a cell not configured for SBFD or with sub-bands. In some of these embodiments, the DCI size budget for a cell configured for SBFD may be doubled compared to a DCI size budget for a cell not configured for SBFD. In this context, the DCI size budget for a cell configured for SBFD can be regarded as a sum DCI size budget for two cells. That is the DCI size budget for a cell can be applied for each DL sub-band. In other embodiments, a DCI size budget for a cell configured for SBFD may be more than ‘3+1’, e.g. ‘x+1’, where x is greater than 3. That is, the total number of different DCI sizes the user device 102 is configured to monitor for a cell is no more than (x+1) for the cell, and the total number of different DCI sizes with C-RNTI that the user device 102 is configured to monitor is no more than x for the cell, where x is greater than 3. In other embodiments, the total number for the DCI size budget is not larger than ‘4’, while the DCI size budget for CRC scrambling with C-RNTI may be up to ‘4’, that is the total number of different DCI sizes the user device 102 is configured to monitor is no more than 4 for the cell, and the total number of different DCI sizes with C-RNTI the user device 102 is configured to monitor is no more than 4 for the cell.

Accordingly, SBFD operation that uses one or more sub-band and/or one or more DL sub-band may achieve better performance with respect to latency reduction and capacity improvement. Moreover, use of a separate or independent PDCCH configuration for the DL sub-band to determine the one or more fields of the DCI used to schedule the DL sub-band may allow for the same DCI size budget as those used for cells without using SBFD, such as through use of a size alignment mechanism, in order to not increase UE complexity.

In addition or alternatively, for embodiments where the PDCCH configurations for the DL BWP and the DL sub-band are different or independent of each other, a search space budget and/or a CORESET budget may be the same as or different than a search space budget and/or a CORESET budget for cells and/or user devices not configured for SBFD. In other embodiments, the search space budget and/or the CORESET budget for cells and/or for user devices configured for SBFD is higher than the budget for cells and/or users devices not configured for SBFD. In addition or alternatively, in various embodiments, a search space budget and/or a CORESET budget are split, such that a first portion of the search space budget and/or the CORESET budget may be allocated to the DL BWP and a second portion of the search space budget and/or the CORESET budget may be allocated to the DL sub-band.

In some embodiments, a search space budget is up to 10 search spaces per BWP and/or a CORESET budget is up to 3 CORESET per BWP. In addition or alternatively, a search space budget is up to 40 search spaces per cell and/or a CORESET budget is up to 12 CORESETs per cell for the user device 102. In case coresetPoolIndex is not provided for a first CORESET, or is provided and has a value 0 for a first CORESET, and is provided and has a value 1 for a second CORESET, the search space budget is up to 10 search spaces per BWP and the CORESET budget is up to 5 CORESETs per BWP, and/or the search space budget is up to 40 search spaces per cell, and the CORESET budget is up to 16 CORESETs per cell for the user device 102. In case the DL sub-band or extended SUL carrier with D slots/symbols is introduced, configured, or supported, and/or in case an independent or different, second PDCCH configuration is configured for the DL sub-band or extended SUL carrier with D slots/symbols, the search space/CORESET budget may be determined according to one of following.

In a first option, the number of search spaces and/or the number of CORESETs may be at least one of: more than 10 search spaces per BWP, more than 40 search spaces per cell, more than 5 CORESETs per BWP, or more than 16 CORESETs per cell. In some of these embodiments, the search space budget is up to 10 search spaces per BWP and/or up to 40 search spaces per cell, and the CORESET budget has more than 5 CORESETs per BWP and/or more than 16 CORESETs per cell. In particular of these embodiments, the DL sub-band is narrow, i.e., below a threshold frequency range. In addition or alternatively, in some of these embodiments, the number of CORESETs may be more than 5 per BWP and/or more than 16 per cell, with the condition of coresetPoolIndex with a different value can be removed or introduce a new RRC signaling. In other embodiments, all of: the number of search spaces per BWP is more than 10, the number of search spaces per cell is more than 40, the number of CORESETs per BWP is more than 5, and the number of CORESETs per cell is more than 16.

In a second option, the user device 102 may utilize an additional (or another) search space budget and/or CORESET budget for the DL sub-band (or D resources on a virtual SUL carrier). In some of these embodiments, the search space budget is divided into two parts, such that for a total number of search spaces in the search space budget, a first number or part is for the DL BWP and a second number of part is for the DL sub-band. In addition or alternatively, the CORESET budget is divided into two parts, such that for a total number of CORESETs in the CORESET budget, a first number or part is for the DL BWP and a second number or part is for the DL sub-band. For example, suppose a search space budget of up 10 search spaces per BWP. For such a budget, up to 8 search spaces may be allocated to the DL BWP, and up to 2 search spaces may be allocated to the DL sub-band respectively. In other embodiments, the number of search spaces and/or CORESETs for the DL BWP and the DL sub-band may be separately or independently determined or defined, irrespective of the total number. This may be the case, irrespective of whether the search space budget and/or the CORESET budget per BWP and/or per cell is the same as or different than those used for user devices not configured with SBFD. In particular embodiments, the search space budget may be up to 10 search spaces and up to 2 search spaces for the DL BWP and the DL sub-band, respectively.

In addition or alternatively, the user device 102 and/or the network device may use one or more blind decode (BD)/control channel element (CCE) budgets for the DL BWP and for the DL sub-band. In some embodiments, the BD/CCE budget used for the DL BWP is also used or applied for the DL sub-band. This may be the case where the DL BWP and the DL sub-band are TDMed. Also, in some embodiments, the DL BWP and the DL sub-band may be counted as only one cell in carrier aggregation (CA) scaling. In addition, for some embodiments, a BD/CCE budget used for the DL BWP for a cell configured with SBFD may be higher than a BD/CCE budget for a cell not configured with SBFD. In particular embodiments, the BD/CCE budget may be higher where the DL BWP and the DL sub-band are FDMed. In various embodiments, a BD/CCE budget for a cell configured with SBFD may be the same as a BD/CCE budget for a cell not configured with SBFD. Irrespective of whether the BD/CCE budget is higher or not, in various embodiments, where a BD/CCE budget for a cell configured with SBFD has a total number of BDs or a total number of CCEs, that total number may be split or divided between the DL BWP and the DL sub-band. and the numbers of blind decodes. In other embodiments, a BD/CCE budget for a cell configured with SBFD may be doubled relative to a BD/CCE budget for a cell not configured with SBFD, so as to be considered doubled as two carriers. In other embodiments, a BD/CCE budget for a cell configured with SBFD may have independent values for the DL sub-band, and/or the sub-band may be counted as one or two cells for purposes of carrier aggregation (CA) scaling.

Additionally, in various embodiments, a BD/CCE budget is up to min(M_{PDCCH}^{max,slot,μ}, M_{PDCCH}^{total,slot,μ}) PDCCH candidates or up to min (C_{PDCCH}^{max,slot,μ}, C_{PDCCH}^{total,slot,μ}) non-overlapped CCEs per slot per cell. That is, for each scheduled cell, the user device 102 is not required to monitor on the active DL BWP with subcarrier spacing (SCS) configuration μ of the scheduling cell more than min(M_{PDCCH}^{max,slot,μ}, M_{PDCCH}^{total,slot,μ}) PDCCH candidates or more than min(C_{PDCCH}^{max,slot,μ}, C_{PDCCH}^{total,slot,μ}) non-overlapped CCEs per slot. Further, similar as the above per slot budget, there are also per span budget, or per N slots budget. In case coresetPoolIndex is not provided for a first CORESET, or is provided and has a value 0 for a first CORESET, and is provided and has a value 1 for a second CORESET, the BD/CCE budget may be up to min(γ·M_{PDCCH}^{max,slot,μ}, M_{PDCCH}^{total,slot,μ}) PDCCH candidates or up to min(γ·C_{PDCCH}^{max,slot,μ}, C_{PDCCH}^{total,slot,μ}) non-overlapped CCEs per slot per cell. If the user device 102 does not report pdcch-BlindDetectionCA or is not provided BDFactorR, γ=R; or if the user device 102 reports pdcch-BlindDetectionCA, the user device 102 may be indicated by BDFactorR either γ=1 or γ=R; where R is a value reported by the user device 102. For example, R=2.

In case the DL subband or extended SUL carrier with D slots/symbols (can also be regarded as a second sub-band) is introduced, configured, or supported, or in case the independent or the second PDCCH configuration is configured for the DL sub-band or extended SUL carrier with D slots/symbols, the BD/CCE budget may be determined and/or in accordance with the following.

At a start point, the BD/CCE budget is a per slot budget, where M_{PDCCH}^{max,slot,μ} and C_{PDCCH}^{max,slot,μ} are shown in Table 1 and Table 2; where M_{PDCCH}^{total,slot,μ} and C_{PDCCH}^{total,slot,μ} are determined as following. The analysis may also be referred to as CA scaling.

If the user device 102 is configured with N_{cells}^{DL,μ} downlink cells with DL BWPs having SCS configuration μ where

$${\sum }_{μ = 0}^{3} {N}_{cells}^{DL , μ} \leq {N}_{cells}^{cap} ,$$

the user device 102 is not required to monitor, on the active DL BWP of the scheduling cell, more than M_{PDCCH}^{total,slot,μ}=M_{PDCCH}^{max,slot,μ} PDCCH candidates or more than C_{PDCCH}^{total,slot,μ}=C_{PDCCH}^{max,slot,μ} non-overlapped CCEs per slot for each scheduled cell, where N_{cells}^{cap} is the number of configured downlink cells if the user device 102 does not provide pdcch-BlindDetectionCA; otherwise, N_{cells}^{cap} is the value of pdcch-BlindDetectionCA. Also, if the user device 102 is configured with N_{cells}^{DL,μ} downlink cells with DL BWPs having SCS configuration μ, where

$${\sum }_{μ = 0}^{3} {N}_{cells}^{DL , μ} > {N}_{cells}^{cap} ,$$

a DL BWP of an activated cell is the active DL BWP of the activated cell, and a DL BWP of a deactivated cell is the DL BWP with index provided by firstActiveDownlinkBWP-Id for the deactivated cell, the user device 102 is not required to monitor more than

$${M}_{PDCCH}^{total , slot , μ} = ⌊ {N}_{cells}^{cap} \cdot {M}_{PDCCH}^{max , slot , μ} \cdot {N}_{cells}^{DL , μ} / {\sum }_{j = 0}^{3} {N}_{cells}^{DL , j} ⌋$$

PDCCH candidates or more than

$${C}_{PDCCH}^{total , slot , μ} = ⌊ {N}_{cells}^{cap} \cdot {M}_{PDCCH}^{max , slot , μ} \cdot {N}_{cells}^{DL , μ} / {\sum }_{j = 0}^{3} {N}_{cells}^{DL , j} ⌋$$

non-overlapped CCEs per slot on the active DL BWP(s) of scheduling cell(s) from the N_{cells}^{DL,μ} downlink cells.

TABLE 1
Maximum number M_{PDCCH}^{max, slot, μ} of monitored
PDCCH candidates per slot for a DL BWP with SCS configuration
μ ∈ {0, 1, 2, 3} for a single serving cell

| | Maximum number of monitored PDCCH candidates |
|---|---|
| μ | per slot and per serving cell M_{PDCCH}^{max, slot, μ} |
| 0 | 44 |
| 1 | 36 |
| 2 | 22 |
| 3 | 20 |

TABLE 2
Maximum number C_{PDCCH}^{max, slot, μ} of non-overlapped
CCEs per slot for a DL BWP with SCS configuration
μ ∈ {0, 1, 2, 3} for a single serving cell

| | Maximum number of non-overlapped CCEs per slot and per serving |
|---|---|
| μ | cell C_{PDCCH}^{max, slot, μ} |
| 0 | 56 |
| 1 | 56 |
| 2 | 48 |
| 3 | 32 |

Also, in some embodiments, a BD/CCE budget is per slot for a DL BWP for a cell. Since the DL sub-band (or D resources on virtual SUL carrier) is located in the UL BWP (or virtual SUL carrier), a BD/CCE budget can be set according to one of the following options.

In a first option, BD/CCE budgets for the DL BWP and the DL sub-band may be the same or have the same numbers of BDs and/or non-overlapped CCEs. In some embodiments, the BD/CCE budget for a DL BWP for a cell configured with SBFD is the same as a BD/CCE budget for a cell not configured with SBFD. In addition or alternatively, the BD/CCE budget used or applied to the DL sub-band is also used or applied to the DL sub-band when the DL BWP and the DL sub-band are TDMed. In other embodiments, the DL BWP and the DL sub-band may have separate or independent BD/CCE budgets. For example, the DL sub-band may have a smaller BD/CCE budget (one or both of the BD or CCE numbers is lower) than the DL BWP. In addition or alternatively, for M_{PDCCH}^{total,slot,μ} and C_{PDCCH}^{total,slot,μ} calculation, the carrier including the DL BWP and the DL sub-band may be counted as one cell in CA scaling.

In a second option, the BD/CCE budget for the DL BWP in a cell configured with SBFD may be larger than a BD/CCE budget for a DL BWP in a cell not configured with SBFD. In particular of these embodiments, in the cell configured with SBFD, the DL BWP and the DL sub-band are FDMed. Also, in some embodiments, a BD/CCE budget may be split for the DL BWP and the DL sub-band, such that a total number of the BD/CCE budget may be split or divided into two parts or numbers, including a first part or number for the DL BWP and a second part or number of the DL sub-band. In particular of these embodiments, the first part and the second part may be overlapped in time domain. Further, in some embodiments, the splitting can be hard splitting or soft splitting, where a splitting factor can be predefined or configured. In other embodiments, the DL BWP and the DL sub-band may be doubled as two carriers, such that the BD/CCE budget is doubled relative to a BD/CCE budget for only a BWP. Such a doubled BD/CCE budget may be determined where the DL BWP and the DL subband are FDMed. In other embodiments, the DL BWP and the DL sub-band may have independent BD/CCE budgets. In some cases, the BD value and/or the CCE value may be smaller for the DL sub-band compared to the DL BWP. In addition or alternatively, for M_{PDCCH}^{total,slot,μ} and C_{PDCCH}^{total,slot,μ} calculation, the carrier including the DL BWP and the DL sub-band may be counted as 1 or 2 cells in CA scaling. In some embodiments, the DL BWP and the DL sub-band are counted as one cell, such as if the BD/CCE budget is the same as for a BD/CCE budget for a DL BWP not configured with SBFD. In particular of these embodiments, the DL BWP configured with SBFD and a BWP not configured with the SBFD have the same SCS and/or the same slot/span. In other embodiments, the DL BWP and the DL sub-band are counted as R cells. In some of these embodiments, R=2 when M_max is doubled. In other of these embodiments, R=1 or 2 when the user device 102 uses an independent BD/CCE budget for the DL sub-band. In still other embodiments, in case there are different SCSs for the DL BWP and the DL sub-band, if the cell including the DL sub-band is a scheduling cell, the cell is counted to each SCS respectively, and the DL BWP and the DL sub-band are counted as one cell or R cells, according to the above description. Also, if the cell including the DL sub-band is a scheduled cell, then the DL BWP and the DL sub-band are counted as one cell or R cells, according to the above description.

In addition or alternatively, overbooking and/or dropping schemes may be applied for the DL sub-band. Such may be the case for embodiments where the DL BWP and the DL sub-band are TDMed and common search space (CSS) type 0/0A/1/2 can be configured in the DL sub-band. In case DL BWP and DL sub-band are FDMed, at least one of: the user device 102 may perform dropping per slot in a unified manner in case the same SCS and/or the same USS index is shared between the DL BWP and the DL sub-band; the user device 102 may perform dropping per slot independent for the DL BWP and the DL sub-band, or only permitted dropping per slot for the DL BWP; or the user device 102 may perform dropping per slot in a unified manner and, in addition, according to an order for the DL BWP and/or the DL sub-band, such as in case the USS index is independent between the DL BWP and the DL subband.

In some embodiments, overbooking is only allowed on a primary cell (PCell), and PDCCH candidates dropping is performed on each USS. That is, all PDCCH candidates in CSS will be monitored and not dropped, the PDCCH candidates in a USS will be monitored and not dropped in case the total candidates combined with the USS is not larger than the BD/CCE budget by a ascending order of USS index per slot. Similarly, the user device 102 may perform PDCCH dropping per span or per X slots. In case the DL subband or extended SUL with D slots/symbols (can be also regarded as the second sub-band) is introduced, configured or supported, and/or in case the independent, second PDCCH configuration is configured for the DL subband or extended SUL with D slots/symbols, the user device 102 and/or the network device 104 may implement overbooking and/or dropping according to one of the following options.

In a first option, overbooking and/or dropping is applied for the DL BWP and for the DL sub-band. This may be the case where the DL BWP and the DL sub-band are TDMed. Also, for some of these embodiments, a CSS type 0/0A/1/2 may be configured in the DL sub-band.

In a second option, in case the DL BWP and the DL sub-band are FDMed, overbooking/dropping may be applied for the cell including the DL sub-band according to one of the following schemes. In a first scheme, the user device 102 may perform dropping per slot in a unified manner in case the same SCS and USS index are shared between the DL BWP and the DL sub-band. That is, the USS index used in the DL BWP and the DL sub-band is shared, which means an index can be configured in the DL BWP or the DL sub-band. In other embodiments, the user device 102 performs dropping independently for the DL BWP and the DL sub-band, or only permits or performs dropping for the DL BWP. That is, the user device 102 may perform dropping per slot on each sub-band, respectively or independent of each other. In some embodiments, the BD/CCE budget and/or the USS index are separately defined on or for each sub-band. In particular of these embodiments, different sub-bands may have different SCS. For example, only DL BWP or one sub-band can be overbooked, and overbooking on another DL sub-band is not permitted. As another example, both of the two sub-bands can be overbooked if CSS type0/0A/1/2 can be configured on both sub-bands. In other embodiments, the user device 102 may perform dropping per slot in a unified manner with an additional order for the DL BWP and/or the DL sub-band. For at least some of these embodiments, the USS index is independent between the DL BWP and the DL sub-band. Of note is that, in various embodiments, the DL BWP and the DL sub-band may be considered or treated as two DL sub-bands. In particular of these embodiments, a shared BD/CCE budget is used for the two DL sub-bands. For some of these embodiments, the two DL sub-bands are configured with the same SCS. For at least some of these embodiments, for a first dropping scheme, a first dropping order between the two DL sub-bands may include: first, perform dropping on the DL sub-band, and then perform dropping on the DL BWP. A second dropping order between the two DL sub-bands may include: first, perform dropping on the DL BWP, and then perform dropping on the DL sub-band. In a second dropping scheme, a dropping order may be between the USS sets on two virtual carriers. For example, several USS sets including at least one USS are configured on each DL sub-band, and then dropping is performed according to the USS sets index by ascending order.

Accordingly, SBFD using one or more UL sub-bands and/or one or more DL sub-bands may achieve better performance with respect to latency reduction and capacity improvement. Moreover, in case independent PDCCH configurations are used for two DL sub-bands or a DL BWP and a DL sub-band, and a second PDCCH configuration for the DL subband is used to determine one or more fields of the DCI used to schedule the DL sub-band, the BD/CCE budget and/or PDCCH candidates dropping can be the same as for cells not configured for SBFD, and/or may employ a splitting mechanism, in order not to increase UE complexity.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: receiving, by a user device, a first physical downlink control channel (PDCCH) configuration for a downlink (DL) bandwidth part (BWP) and a second PDCCH configuration for a first sub-band within an uplink (UL) BWP or within the DL BWP; and receiving, by the user device, a PDCCH in the first sub-band according to the second PDCCH configuration or transmitting, by the user device, an UL transmission in the UL BWP or in a second sub-band.

A second aspect includes a method for wireless communication that includes: determining, by a network device, a first physical downlink control channel (PDCCH) configuration for a downlink (DL) bandwidth part (BWP) and a second PDCCH configuration for a first sub-band within an uplink (UL) BWP or within the DL BWP; and transmitting, by the network device, a PDCCH in the first sub-band according to the second configuration or receiving, by the network device, an UL transmission in the UL BWP or in a second sub-band.

A third aspect includes any of the first or second aspects, and further includes wherein the first sub-band comprises a downlink (DL) sub-band or a flexible sub-band, and the second sub-band comprises an uplink (UL) sub-band or a flexible sub-band.

A fourth aspect includes any of the first through third aspects, and further includes wherein the first PDCCH configuration and the second PDCCH configuration are a same PDCCH configuration.

A fifth aspect includes the fourth aspect, and further includes wherein the same PDCCH configuration indicates at least one of: independent control resource sets (CORESETs) or independent search spaces for the first sub-band and the DL BWP.

A sixth aspect includes the fifth aspect, and further includes wherein a CORESET used for the PDCCH in the DL sub-band is configured within the DL BWP, the UL BWP or the first sub-band.

A seventh aspect includes the fourth aspect, and further includes wherein the same PDCCH configuration indicates at least one of: a same control resource set (CORESET) or a same search space for the DL BWP and the first sub-band.

An eighth aspect includes the seventh aspect, and further includes wherein a collision between a monitoring occasion (MO) and UL resources of the UL BWP cause the user device to override one of the MO and the UL resources in favor of the other of the MO and the UL resources.

A ninth aspect includes the fourth aspect, and further includes wherein a same downlink control information (DCI) format is used for DL transmissions in the DL BWP and the first sub-band.

A tenth aspect includes the ninth aspect, and further includes wherein the same DCI format comprises a bandwidth part indicator that indicates whether to switch the DL BWP or the UL BWP, or that the field is reserved for sub-band scheduling.

An eleventh aspect includes any of the first or second aspects, and further includes wherein the first PDCCH configuration and the second PDCCH configuration are different configurations.

A twelfth aspect includes the eleventh aspect, and further includes wherein the second PDCCH configuration determines one or more fields in a downlink control information (DCI) format used for scheduling a DL transmission in the first sub-band.

A thirteenth aspect includes the twelfth aspect, and further includes wherein the DCI format comprises an indication that indicates whether the DCI format is for the first sub-band or the DL BWP.

A fourteenth aspect includes any of the twelfth or thirteenth aspects, and further includes wherein a total number of different DCI sizes with a cell radio network temporary identifier (C-RNTI) that the user device monitors is up to four.

A fifteenth aspect includes the eleventh aspect, and further includes wherein at least one of: a search space budget for the user device comprises at least one of: more than 10 search spaces per BWP or more than 40 search spaces per cell; a CORESET budget for the user device comprises at least one of: more than 5 CORESETs per BWP or more than 16 CORESETs per cell; a search space budget comprises a first part for the DL BWP and a second part for the DL sub-band; or a CORESET budget comprises a first part for the DL BWP and a second part for the DL sub-band.

A sixteenth aspect includes the eleventh aspect, and further includes wherein a blind decode budget or a control channel element (CCE) budget are the same for the DL BWP and the DL sub-band when the DL BWP and the DL sub-band are time-division multiplexed.

A seventeenth aspect includes the sixteenth aspect, and further includes wherein the DL BWP and the DL sub-band are counted as only one cell for carrier aggregation scaling.

An eighteenth aspect includes the eleventh aspect, and further includes wherein a blind decode budget or a control channel element (CCE) budget comprises a first part for the DL BWP and a second part for the DL sub-band.

A nineteenth aspect includes the eighteenth aspect, and further includes wherein the DL sub-band is counted as one or more cells for carrier aggregation scaling.

A twentieth aspect includes the eleventh aspect, and further includes wherein the user device performs dropping per slot for the DL BWP and the DL sub-band, wherein the dropping per slot comprises one of: dropping per slot in a unified manner when a subcarrier spacing (SCS) and a user equipment-specific search space (USS) is shared between the DL BWP and the DL sub-band; dropping per slot for the DL BWP and the DL sub-band independent of each other; dropping per slot for the DL BWP and not for the DL sub-band; or dropping per slot for the DL BWP and the DL sub-band in a unified manner and according to a predetermined order when the DL BWP and the DL sub-band have independent user equipment (UE)-specific search spaces (USS).

A twenty-first aspect includes a method for wireless communication that includes: receiving, by a user device, a configuration of a downlink (DL) sub-band within an uplink (UL) bandwidth part (BWP); receiving, by the user device, a configuration of an UL sub-band within a DL BWP; and performing, by the user device, a DL transmission in the DL sub-band or an UL transmission in the UL sub-band.

A twenty-second aspect includes a method for wireless communication that includes: configuring, by a network device, a downlink (DL) sub-band within an uplink (UL) bandwidth part (BWP); configuring, by the network device, an UL sub-band within a DL BWP; and transmitting, by the network device, a DL transmission in the DL sub-band and/or receiving, by the network device, an UL transmission in the UL sub-band.

A twenty-third aspect includes any of the twenty-first or twenty-second aspects, and further includes wherein one of: the DL sub-band and the UL sub-band have a same center frequency, a same frequency resource, and different time resources; the DL sub-band and the UL sub-band have a same center frequency, different frequency resources, and different time resources; the DL sub-band and the UL sub-band have a same frequency resource or different frequency resources, and a same time resource; or the time-frequency resources for the DL sub-band and the UL sub-band are independently determined by at least one of the network device or the user device.

A twenty-fourth aspect includes any of the twenty-first or twenty-second aspects, and further includes wherein collision resolution or a fallback mechanism is applied in response to overlapped resources between the DL sub-band and the UL sub-band.

A twenty-fifth aspect includes any of the twenty-first or twenty-second aspects, and further includes wherein frequency resources of at least one of a gap, the DL sub-band, or the UL sub-band are indicated within DL BWP or UL BWP.

A twenty-sixth aspect includes the twenty-fifth aspect, and further includes wherein at least one gap on one inside of resources allocated to the DL sub-band or the UL sub-band, or both insides of the resources allocated to the DL sub-band or the UL sub-band is determined by an indication.

A twenty-seventh aspect includes a wireless communications apparatus comprising a processor and a memory, wherein the processor is configured to read code from the memory to implement any of the first through twenty-sixth aspects.

A twenty-eighth aspect includes a computer program product comprising a computer-readable program medium comprising code stored thereupon, the code, when executed by a processor, causing the processor to implement any of the first through twenty-sixth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
receiving, by a user device, a first physical downlink control channel (PDCCH) configuration for a downlink (DL) bandwidth part (BWP) and a second PDCCH configuration for a first sub-band within an uplink (UL) BWP or within the DL BWP; and
receiving, by the user device, a PDCCH in the first sub-band according to the second PDCCH configuration or transmitting, by the user device, an UL transmission in the UL BWP or in a second sub-band.

2. A method for wireless communication, the method comprising:
determining, by a network device, a first physical downlink control channel (PDCCH) configuration for a downlink (DL) bandwidth part (BWP) and a second PDCCH configuration for a first sub-band within an uplink (UL) BWP or within the DL BWP; and
transmitting, by the network device, a PDCCH in the first sub-band according to the second configuration or receiving, by the network device, an UL transmission in the UL BWP or in a second sub-band.

3. The method of claim 1, wherein the first sub-band comprises a downlink (DL) sub-band or a flexible sub-band, and the second sub-band comprises an uplink (UL) sub-band or a flexible sub-band.

4. The method of claim 1, wherein the first PDCCH configuration and the second PDCCH configuration are a same PDCCH configuration.

5. The method of claim 4, wherein the same PDCCH configuration indicates at least one of: independent control resource sets (CORESETs) or independent search spaces for the first sub-band and the DL BWP.

6. The method of claim 5, wherein a CORESET used for the PDCCH in the DL sub-band is configured within the DL BWP, the UL BWP or the first sub-band.

7. The method of claim 4, wherein the same PDCCH configuration indicates at least one of: a same control resource set (CORESET) or a same search space for the DL BWP and the first sub-band.

8. The method of claim 7, wherein a collision between a monitoring occasion (MO) and UL resources of the UL BWP cause the user device to override one of the MO and the UL resources in favor of the other of the MO and the UL resources.

9. The method of claim 4, wherein a same downlink control information (DCI) format is used for DL transmissions in the DL BWP and the first sub-band.

10. The method of claim 9, wherein the same DCI format comprises a bandwidth part indicator that indicates whether to switch the DL BWP or the UL BWP, or that the field is reserved for sub-band scheduling.

11. The method of claim 1, wherein the first PDCCH configuration and the second PDCCH configuration are different configurations.

12. The method of claim 11, wherein the second PDCCH configuration determines one or more fields in a downlink control information (DCI) format used for scheduling a DL transmission in the first sub-band.

13. The method of claim 12, wherein the DCI format comprises an indication that indicates whether the DCI format is for the first sub-band or the DL BWP.

14. The method of claim 12, wherein a total number of different DCI sizes with a cell radio network temporary identifier (C-RNTI) that the user device monitors is up to four.

15. The method of claim 11, wherein at least one of:
a search space budget for the user device comprises at least one of: more than 10 search spaces per BWP or more than 40 search spaces per cell;
a CORESET budget for the user device comprises at least one of: more than 5 CORESETs per BWP or more than 16 CORESETs per cell;
a search space budget comprises a first part for the DL BWP and a second part for the DL sub-band; or
a CORESET budget comprises a first part for the DL BWP and a second part for the DL sub-band.

16. The method of claim 11, wherein a blind decode budget or a control channel element (CCE) budget are the same for the DL BWP and the DL sub-band when the DL BWP and the DL sub-band are time-division multiplexed.

17. The method of claim 16, wherein the DL BWP and the DL sub-band are counted as only one cell for carrier aggregation scaling.

18. The method of claim 11, wherein a blind decode budget or a control channel element (CCE) budget comprises a first part for the DL BWP and a second part for the DL sub-band.

19. The method of claim 18, wherein the DL sub-band is counted as one or more cells for carrier aggregation scaling.

20. The method of claim 11, wherein the user device performs dropping per slot for the DL BWP and the DL sub-band, wherein the dropping per slot comprises one of:
dropping per slot in a unified manner when a subcarrier spacing (SCS) and a user equipment-specific search space (USS) is shared between the DL BWP and the DL sub-band;
dropping per slot for the DL BWP and the DL sub-band independent of each other;
dropping per slot for the DL BWP and not for the DL sub-band; or
dropping per slot for the DL BWP and the DL sub-band in a unified manner and according to a predetermined order when the DL BWP and the DL sub-band have independent user equipment (UE)-specific search spaces (USS).
